(19) United States
(12) Patent Application Publication
(10) Pub. No.: US 2022/0414077 A1
(43) Pub. Date: Dec. 29, 2022

(54) GRAPH SEARCHING APPARATUS, GRAPH SEARCHING METHOD, AND COMPUTER-READABLE RECORDING MEDIUM

(71) Applicant: NEC Corporation, Minato-ku, Tokyo (JP)

(72) Inventor: Harumichi YOKOYAMA, Tokyo (JP)

(73) Assignee: NEC Corporation, Minato-ku, Tokyo (JP)

(21) Appl. No.: 17/779,653

(22) PCT Filed: Dec. 5, 2019
(86) PCT No.: PCT/JP2019/047708

§ 371 Date: May 25, 2022

(51) Int. Cl. G06F 16/22; G06F 16/28

(52) U.S. Cl. CPC G06F 16/22; G06F 16/285

(57) ABSTRACT

A graph searching apparatus 10 includes: a generation unit 11 for selecting a plurality of vertices based on an adjacency relationship of vertices included in a graph and generating a frontier matrix in which different labels are respectively set for elements corresponding to the selected vertices; and a classification unit 12 for classifying the vertices using the frontier matrix and an adjacency matrix representing the adjacency relationship of the vertices included in the graph.

### TECHNICAL FIELD

The present invention relates to a graph searching apparatus and a graph searching method for executing a graph search, and further relates to a computer-readable recording medium on which a program for realizing them is recorded.

### BACKGROUND ART

A graph search is an important technique for analyzing a Social Networking Service (SNS) (for example, clustering relationships between users) and analyzing a road connecting points on an electronic map (for example, shortest route search between the points). Further, in a graph search, it is known that the structure of the graph is represented using an adjacency matrix.

As a related technique, Patent Document 1 discloses a pattern extraction apparatus capable of efficiently obtaining the number of connected components of a graph. According to the pattern extraction apparatus of Patent Document 1, the number of connected components of a graph is obtained by representing a connection relationship of a pattern by using a vertex adjacency matrix and counting the number of diagonalized blocks of the vertex adjacency matrix.

### LIST OF RELATED ART DOCUMENTS

### Patent Document

Patent Document 1: Japanese Patent Laid-Open Publication No. 2000-322514

### SUMMARY OF INVENTION

### Technical Problems

However, in a graph search, as the number of vertices increases, the number of matrix elements increases, and thus the adjacency matrix becomes large. Therefore, the time required for the graph search increases. Therefore, there is a desire to reduce the time required for the graph search.

An example of an object of the present invention is to provide a graph searching apparatus and a graph searching method that reduce the time required for the graph search, and a computer-readable recording medium.

### Solution to the Problems

In order to achieve the above object, a graph searching apparatus in one aspect of the present invention includes:

a generation means for selecting a plurality of vertices based on an adjacency relationship of vertices included in a graph and generating a frontier matrix in which different labels are respectively set for elements corresponding to the selected vertices; and a classification means for classifying the vertices using the frontier matrix and an adjacency matrix representing the adjacency relationship of the vertices included in the graph.

Further, in order to achieve the above object, a graph searching method in one aspect of the present invention includes:

(a) selecting a plurality of vertices based on an adjacency relationship of vertices included in a graph and generating a frontier matrix in which different labels are respectively set for elements corresponding to the selected vertices; and

(b) classifying the vertices using the frontier matrix and an adjacency matrix representing the adjacency relationship of the vertices included in the graph.

Further, in order to achieve the above object, a computer-readable recording medium in one aspect of the present invention includes a program recorded thereon, the program including instructions that cause a computer to carry out:

(a) selecting a plurality of vertices based on an adjacency relationship of vertices included in a graph and generating a frontier matrix in which different labels are respectively set for elements corresponding to the selected vertices; and

(b) classifying the vertices using the frontier matrix and an adjacency matrix representing the adjacency relationship of the vertices included in the graph.

### Advantageous Effects of the Invention

As described above, according to the present invention, the time required for the graph search can be reduced.

### BRIEF DESCRIPTION OF THE DRAWINGS

FIG. 1 is a diagram for describing an example of a graph searching apparatus.

FIG. 2 is a diagram for describing an example of an adjacency matrix and a frontier matrix.

FIG. 3 is a diagram for describing an example of the adjacency matrix and the frontier matrix.

FIG. 4 is a diagram for describing an example of the adjacency matrix and the frontier matrix.

FIG. 5 is a diagram for describing an example of the adjacency matrix and the frontier matrix.

FIG. 6 is a diagram for describing an example of the adjacency matrix and the frontier matrix.

FIG. 7 is a diagram for describing an example of a system including the graph searching apparatus.

FIG. 8 is a diagram for describing an example of selecting vertices.

FIG. 9 is a diagram for describing an operation of Modification 1.

FIG. 10 is a diagram for describing the operation of Modification 1.

FIG. 11 is a diagram for describing the operation of Modification 1.

FIG. 12 is a diagram for describing an operation of Modification 2.

FIG. 13 is a diagram for describing the operation of Modification 2.

FIG. 14 is a diagram for describing the operation of Modification 2.

FIG. 15 is a diagram for describing an example of the operation of the graph searching apparatus.

FIG. 16 is a diagram illustrating an example of a computer for realizing the graph searching apparatus.

### EXAMPLE EMBODIMENT

### Example Embodiment

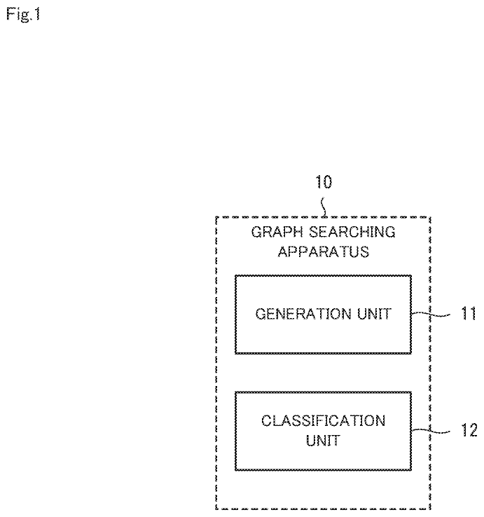

Hereinafter, an example embodiment of the present invention will be described with reference to FIGS. 1 to 16.

[Device Configuration]

First, a configuration of a graph searching apparatus 10 in the present example embodiment will be described with reference to FIG. 1. FIG. 1 is a diagram for describing an example of the graph searching apparatus.

The graph searching apparatus 10 illustrated in FIG. 1 is a device for reducing the time required for graph search. Further, as illustrated in FIG. 1, the graph searching apparatus 10 includes a generation unit 11 and a classification unit 12.

Among them, the generation unit 11 selects a plurality of vertices based on an adjacency relationship of vertices included in a graph, and generates a frontier matrix in which different labels are respectively set for elements corresponding to the selected vertices. The classification unit 12 classifies the vertices using the frontier matrix and an adjacency matrix representing the adjacency relationship of the vertices included in the graph.

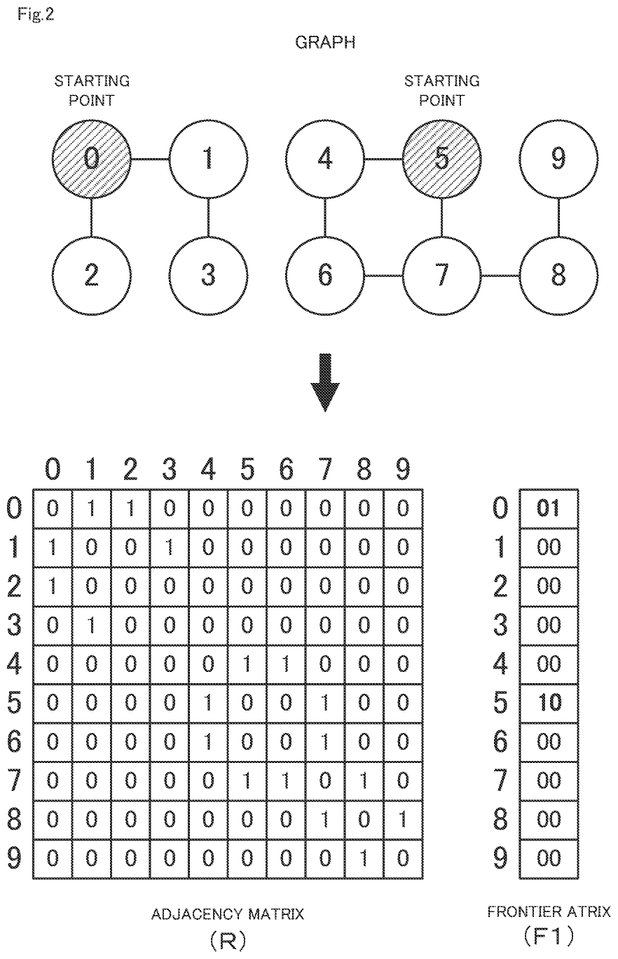

FIGS. 2 to 6 are diagrams for describing an example of the adjacency matrix and the frontier matrix. The graph illustrated in FIG. 2 has vertices 0 to 9. The adjacency matrix is a matrix for representing vertices adjacent to the target vertices. The frontier matrix is a matrix used to classify the vertices of the graph into connected sets. A connected set is a set in which reachable vertices are classified.

An adjacency matrix (R) of FIG. 2 is an adjacency matrix corresponding to the graph of FIG. 2. The adjacency relationship of the vertex 0 will be described. Since the vertices adjacent to the vertex 0 of the graph are the vertices 1 and 2, in the adjacency matrix of FIG. 2, “1” is set for the elements corresponding to the vertices 1 and 2 in a row and a column corresponding to the vertex 0. Since the vertices other than the vertices 1 and 2 are not adjacent to the vertex 0, “0” is set for the elements corresponding to the vertices other than the vertices 1 and 2. Note that for each of the vertices present in the graph other than the vertex 0, the adjacency relationship is represented in the adjacency matrix in the same manner as the vertex 0.

A frontier matrix (F1) of FIG. 2 is a frontier matrix used at the start of classification. The example of FIG. 2 illustrates a case where the vertices 0 and 5 of the graph are selected as the vertices that are starting points at the start of classification. A label “01” is assigned to the element of the frontier matrix (F1) corresponding to the vertex 0 that is the starting point. Further, a label “10” is assigned to the element of the frontier matrix (F1) corresponding to the vertex 5 that is the starting point. Note that “00” is assigned as an initial value to vertices other than the vertices 0 and 5, that are not the starting points.

A bit width of a label is determined based on the number of vertices that are the starting points. In the frontier matrix of FIG. 2, since there are two vertices that are the starting points, the bit width is 2 bits. If there are three vertices that are starting points, the bit width is 3 bits. If the bit width is 3 bits, it is set to, for example, “100”.

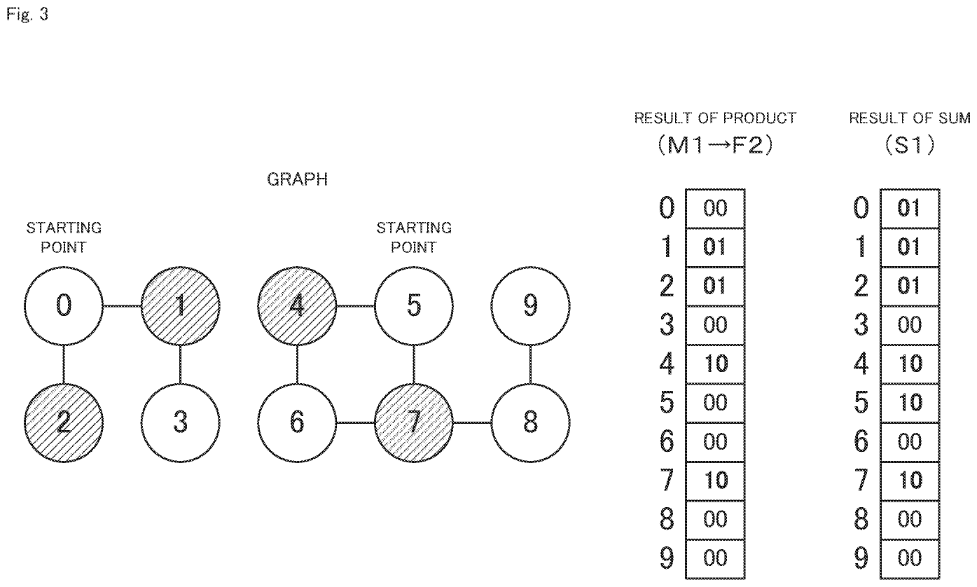

The matrix of FIG. 3 (first matrix) is a result (M1) of the product of the adjacency matrix (R) and the frontier matrix (F1) of FIG. 2. In the example of FIG. 3, since the vertices adjacent to the vertex 0 that are the starting points are the vertices 1 and 2, in the result (M1) of the product, the elements corresponding to the vertices 1 and 2 are labeled with the label “01” indicating that they are connected to the vertex 0. Further, since the vertices adjacent to the vertices 5 that are the starting points are the vertices 4 and 7, in the result (M1) of the product, the elements corresponding to the vertices 4 and 7 are labeled with the label “10” indicating that they are connected to the vertex 5.

Note that when calculating the product of matrices, the logical product is used to calculate the product of the elements, and the logical sum is used to calculate the sum of the elements.

Subsequently, the result (M1) of the product of FIG. 3 is used as a frontier matrix (F2). In the example of FIG. 3, since the result (M1) of the product has no element corresponding to a searched vertex, the result (M1) of the product is used as a new frontier matrix (F2). However, if the result (M1) of the product already has an element corresponding to a searched vertex (classified vertex), the element corresponding to the searched vertex is excluded from the result (M1) of the product.

Subsequently, a result (S1: second matrix) of the sum of the result (M1) of the product of FIG. 3 and the frontier matrix (F1) of FIG. 2 is calculated. The result (S1) of the sum is a matrix for representing the searched vertices. Therefore, in the result (S1) of the sum of FIG. 3, the elements corresponding to the vertices 0, 1, 2, 4, 5, and 7, which have already been searched, are labeled.

Note that when calculating the sum of matrices, the logical sum is used to calculate the sum of the elements.

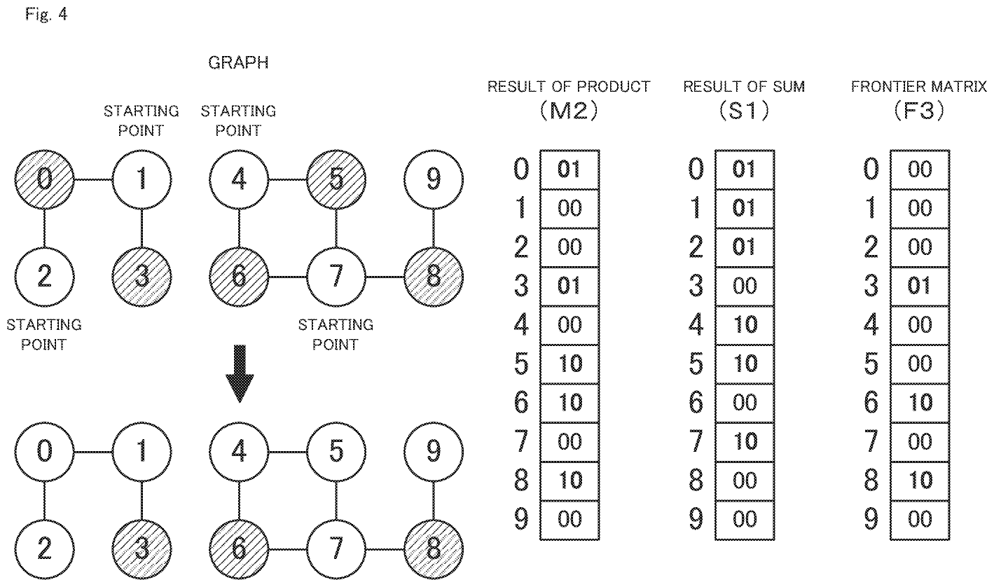

The matrix (first matrix) of FIG. 4 is a result (M2) of the product of the adjacency matrix (R) of FIG. 2 and the frontier matrix (F2) of FIG. 3. In the example of FIG. 4, since the starting points are the vertices 1 and 2 adjacent to the vertex 0, in the result (M2) of the product, the elements corresponding to the vertices 0 and 3 are labeled with the label “01” indicating that they are connected to the vertex 0. Further, since the starting points are the vertices 4 and 7 adjacent to the vertex 5, in the result (M2) of the product, the elements corresponding to the vertices 5, 6, and 8 are labeled with the label “10” indicating that they are connected to the vertex 5.

Subsequently, a frontier matrix (F3) is generated using the result (M2) of the product and the result (S1) of the sum of FIG. 4. In the example of FIG. 4, since the result (M2) of the product has labels for the elements corresponding to the searched vertices 0, 1, 2, 4, 5, and 7, the elements corresponding to the searched vertices are excluded from the result (M2) of the product. Then, as illustrated in FIG. 4, a new frontier matrix (F3) is generated in which the labeled elements corresponding to the vertices 3, 6, and 8 remain and “00” is assigned to other vertices.

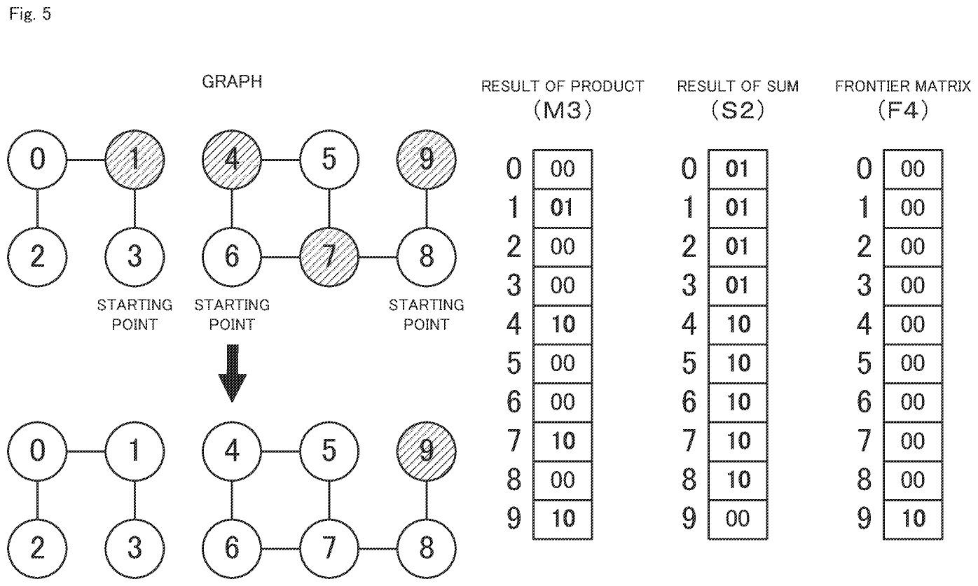

Subsequently, a result (S2: second matrix) of the sum illustrated in FIG. 5 is calculated. The result (S2) of the sum is the result of the sum of the result (M2) of the product of FIG. 4 and the frontier matrix (F2) of FIG. 3. Since the result (S2) of the sum is a matrix representing the vertices that have already been searched, the elements corresponding to the vertices 0, 1, 2, 3, 4, 5, 6, 7, and 8 are labeled.

The matrix (first matrix) of FIG. 5 is a result (M3) of the product of the adjacency matrix (R) of FIG. 2 and the frontier matrix (F3) of FIG. 4. In the example of FIG. 5, since the starting point is the vertex 3, the element corresponding to the vertex 1 of the result (M3) of the product is labeled with the label “01” indicating that it is connected to the vertex 0. Further, in the example of FIG. 5, since the starting points are the vertices 6 and 8, the elements corresponding to the vertices 4, 7, and 9 of the result (M3) of the product are labeled with the label “10” indicating that they are connected to the vertex 5.

Subsequently, a frontier matrix (F4) is generated using the result (M3) of the product and the result (S2) of the sum of FIG. 5. In the example of FIG. 5, since the result (M3) of the product has labels for the elements corresponding to the searched vertices 0 to 8, the elements corresponding to the searched vertices are excluded from the result (M3) of the product. Then, as illustrated in FIG. 5, a new frontier matrix (F4) is generated in which the labeled element corresponding to the vertex 9 remains and “00” is assigned to the other vertices.

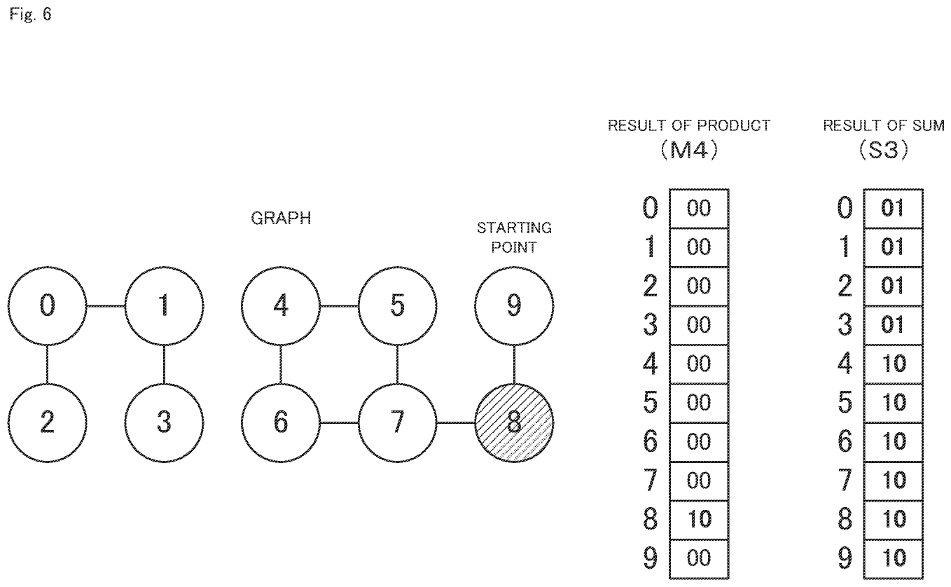

Subsequently, a result (S3: second matrix) of the sum illustrated in FIG. 6 is calculated. The result (S3) of the sum is the result of the sum of the result (M3) of the product of FIG. 5 and the frontier matrix (F3) of FIG. 4. In the result (S3) of the sum, the elements corresponding to vertices 0 to 3 are labeled with the label “01”, and the elements corresponding to the vertices 4 to 9 are labeled with the label “10”. That is, the elements corresponding to the vertices are classified by the labels in the same way as the connected set of the vertices illustrated in the graph.

Note that when the elements corresponding to all of the vertices of the result (second matrix) of the sum are labeled, processing for classifying the vertices is terminated.

As described above, in the present example embodiment, since the adjacency matrix and the frontier matrix are used to classify the vertices, the time required for the graph search can be reduced.

In addition, conventionally, when performing a graph search using a processor or the like, one vertex is selected, graph search is completed for the selected vertex, then one next vertex is selected, and the graph search is sequentially performed. However, in the present example embodiment, since the vertices are selected and the graph search is performed in parallel, the number of steps required for the graph search can be reduced as compared with the conventional case.

[System Configuration]

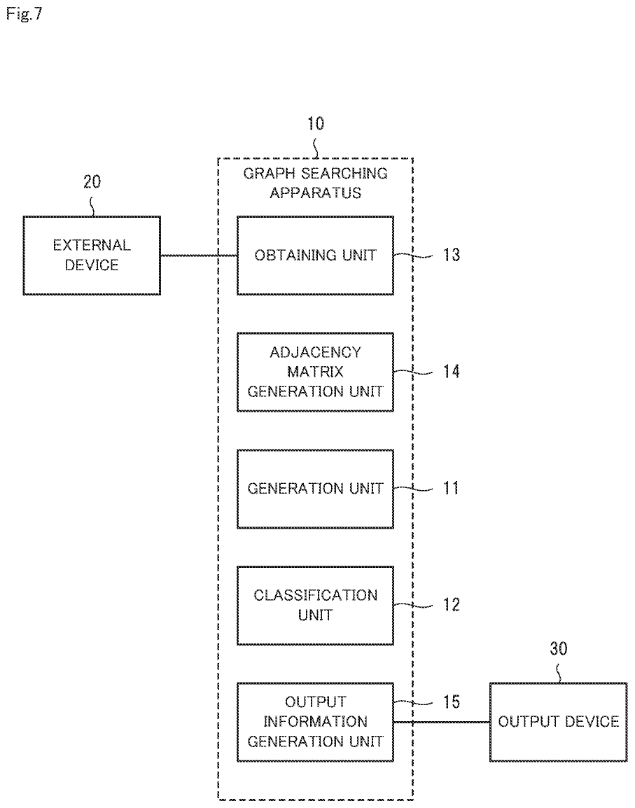

Subsequently, the configuration of the graph searching apparatus 10 in the present example embodiment will be described more specifically with reference to FIG. 7. FIG. 7 is a diagram for describing an example of a system including the graph searching apparatus.

As illustrated in FIG. 7, the system in the present example embodiment includes the graph searching apparatus 10, an external device 20, and an output device 30. The graph searching apparatus 10 has an obtaining unit 13, an adjacency matrix generation unit 14, and an output information generation unit 15 in addition to the generation unit 11 and the classification unit 12.

The system will be described.

The graph searching apparatus 10 is, for example, an information processing device such as a vector processor, a Central Processing Unit (CPU), a Field-Programmable Gate Array (an FPGA), or a server computer, a personal computer, or a mobile terminal equipped with them.

The external device 20 is a device having data required for graph search. Specifically, the external device 20 may be a storage device such as a database that stores data used for analysis of SNS, analysis of a road connecting points on an electronic map, or the like, a server computer, a personal computer, a mobile terminal, or the like. Note that the external device 20 communicates with the graph searching apparatus 10 by wire or wirelessly, and transmits the data to the graph searching apparatus 10.

The output device 30 obtains output information converted into a format capable of being output by the output information generation unit 15, and outputs a generated image, sound, and the like based on the output information. The output device 30 is, for example, an image display device using a liquid crystal display, an organic Electro Luminescence (EL), or a Cathode Ray Tube (CRT). Further, the image display device may include, for example, a sound output device such as a speaker. Note that the output device 30 may be a printing device such as a printer.

The graph searching apparatus will be described.

The obtaining unit 13 obtains data required for performing a graph search on a target graph. Specifically, the obtaining unit 13 receives the data transmitted from the external device 20 and outputs the data to the adjacency matrix generation unit 14. The obtaining unit 13 communicates with, for example, the external device 20 by wire or wirelessly and receives the data.

The adjacency matrix generation unit 14 generates an adjacency matrix representing the adjacency relationship of the vertices for the target graph using the data required for the graph search. Specifically, the adjacency matrix generation unit 14 first obtains the data required for the graph search. Subsequently, the adjacency matrix generation unit 14 generates the adjacency matrix corresponding to the target graph using the vertices included in the target graph and the adjacency relationship of each vertex. The adjacency matrix generation unit 14 generates, for example, the adjacency matrix (R) as illustrated in FIG. 2 described above.

The generation unit 11 selects vertices based on the adjacency relationship of the vertices included in the graph, and generates the frontier matrix in which different labels are respectively set for the elements corresponding to the selected vertices. Specifically, first, the generation unit 11 selects vertices from the vertices included in the graph.

For selection of vertices, for example, a user may select the vertices as appropriate, or the generation unit 11 may select the vertices. Note that when the generation unit 11 selects the vertices, the generation unit 11 may select preset vertices or may select the vertices based on the number of vertices.

Subsequently, the generation unit 11 sets different labels for the elements corresponding to the selected vertices of the frontier matrix having the same number of rows as the number of vertices. The generation unit 11 generates, for example, the frontier matrix (F1) as illustrated in FIG. 2 described above. Further, the generation unit 11 determines the bit width of the label based on the number of selected vertices.

The classification unit 12 generates a new frontier matrix by referring to the result (second matrix) of the sum representing the vertices for which the graph search has been completed and excluding the elements corresponding to the searched vertices from the result (first matrix) of the product of the adjacency matrix and the frontier matrix. Thereafter, the classification unit 12 classifies the vertices by calculating the sum of the result of the product and the result of the sum and generating a new result (second matrix) of the sum.

Specifically, first, the classification unit 12 obtains the adjacency matrix and the frontier matrix. Subsequently, the classification unit 12 calculates the result of the product of the adjacency matrix and the frontier matrix. Subsequently, the classification unit 12 generates a new frontier matrix by referring to the result of the sum and excluding elements corresponding to searched vertices from the result of the product if the result of the product has searched vertices. The generation unit 11 generates the new frontier matrices (F3) (F4), for example, as described above with reference to FIGS. 4 and 5.

Subsequently, the classification unit 12 calculates the sum of the result of the product and the result of the sum, and generates a new result of the sum, to classify the vertices. The generation unit 11 generates the new results (S1), (S2), and (S3) of the sum, for example, as described above with reference to FIGS. 3 to 6.

The output information generation unit 15 generates the output information used to output one or more of the graph, the adjacency matrix, the frontier matrix, the result of the product, the result of the sum, and the like to the output device. Thereafter, the output information generation unit 15 transmits the generated output information to the output device.

[Modification 1] If the vertices selected by the generation unit 11 are in the same connected set, different labels will be respectively set for the selected vertices, and therefore the classification unit 12 will attach different labels respectively to vertices in the same connected set. In this case, the classification will be different from the actual graph.

In Modification 1, even if different labels are respectively set for vertices in the same connected set, the labels of the vertices in the same connected set are unified to the same label, and thus they can be classified in the same way as the actual graph.

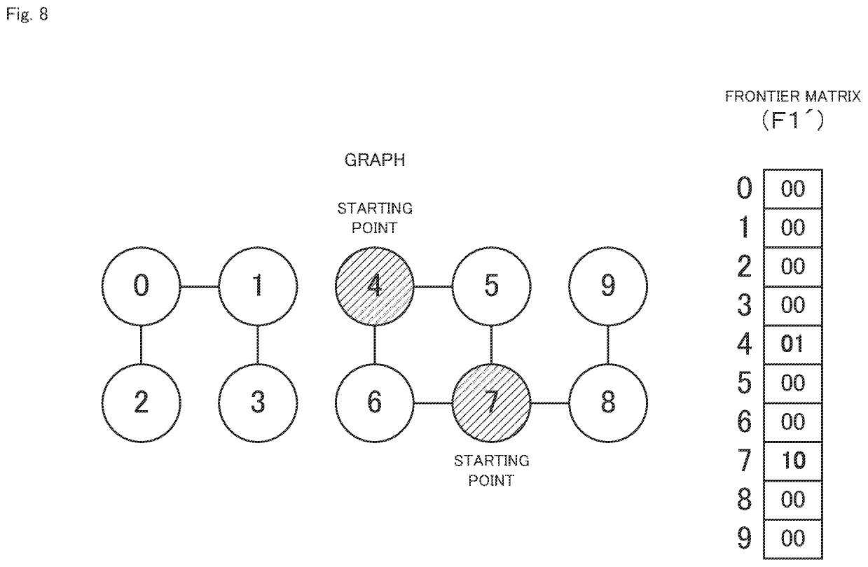

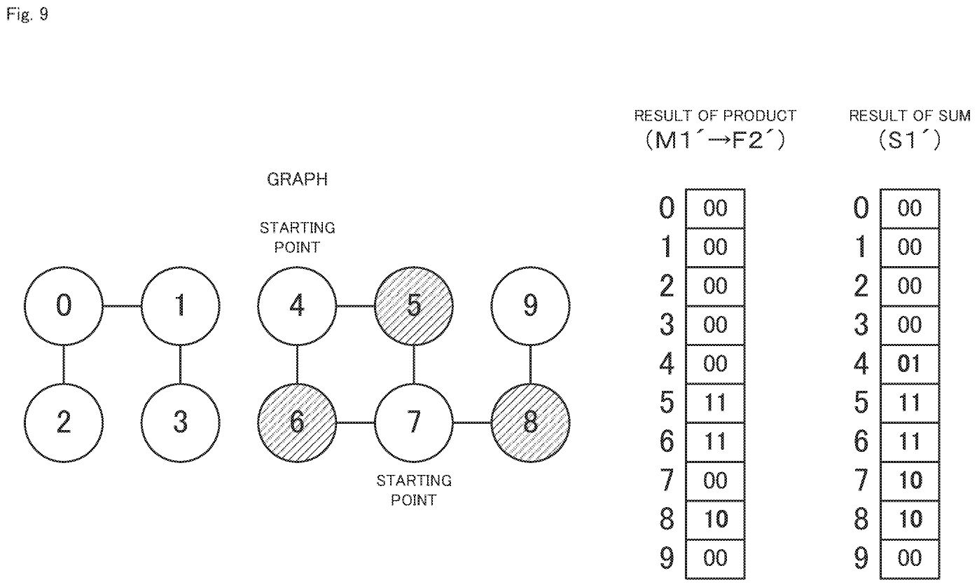

Modification 1 will be described with reference to FIGS. 8 to 11. FIG. 8 is a diagram for describing an example of selecting vertices. FIGS. 9, 10, and 11 are diagrams for describing an operation of Modification 1.

The example of FIG. 8 is an example in which the generation unit 11 generates a frontier matrix (F1′) when the vertices 4 and 7 are selected as the starting points.

The example of FIG. 9 is an example in which the classification unit 12 generates a result (M1′) of the product of the adjacency matrix (R) of FIG. 2 and the frontier matrix (F1′) of FIG. 8. At this time, since the vertices adjacent to the vertex 4 are the vertices 5 and 6, and the vertices adjacent to the vertex 7 are the vertices 5, 6, and 8, the vertices 5 and 6 are duplicated. In such a case, the classification unit 12 attaches a label “11” representing the logical sum of the label “01” set for the vertex 4 and the label “10” set for the vertex 7 to the elements corresponding to the duplicate vertices 5 and 6.

Subsequently, the result (M1′) of the product of FIG. 9 is used as a frontier matrix (F2′). In the example of FIG. 9, since the result (M1′) of the product does not have an element corresponding to the searched vertices, the result (M1′) of the product is used as a new frontier matrix (F2′).

Subsequently, a result (S1′: second matrix) of the sum of the result (M1′) of the product of FIG. 9 and the frontier matrix (F1′) of FIG. 8 is calculated. The sum result (S1′) is a matrix for representing the searched vertices. Therefore, in the result (S1′) of the sum of FIG. 9, the elements corresponding to the vertices 4, 5, 6, 7, and 8 that have already been searched are labeled.

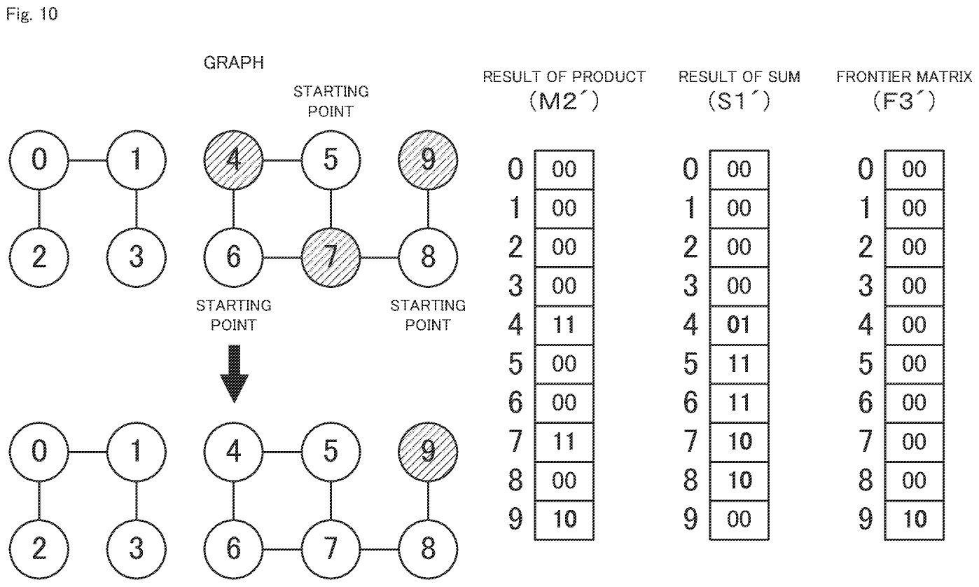

The example of FIG. 10 is an example in which the classification unit 12 generates the result (M2′) of the product of the adjacency matrix (R) of FIG. 2 and the frontier matrix (F2′) of FIG. 9. At this time, since the vertices adjacent to the vertex 5 are the vertices 4 and 7, and the vertices adjacent to the vertex 6 are the vertices 4 and 7, the adjacent vertices are duplicated for the vertices 4 and 7. In such a case, the classification unit 12 attaches the label “11” to the elements corresponding to the duplicate vertices 4 and 7.

Subsequently, the classification unit 12 generates a frontier matrix (F3′) using the result (M2′) of the product and the result (S1′) of the sum of FIG. 10. In the example of FIG. 10, since the result (M2′) of the product has labels for the elements corresponding to the searched vertices 4, 7, and 9, the elements corresponding to the searched vertices are excluded from the result (M2′) of the product. Then, as illustrated in FIG. 10, a new frontier matrix (F3′) is generated in which the labeled element corresponding to the vertex 9 remains and “00” is assigned to the other vertices.

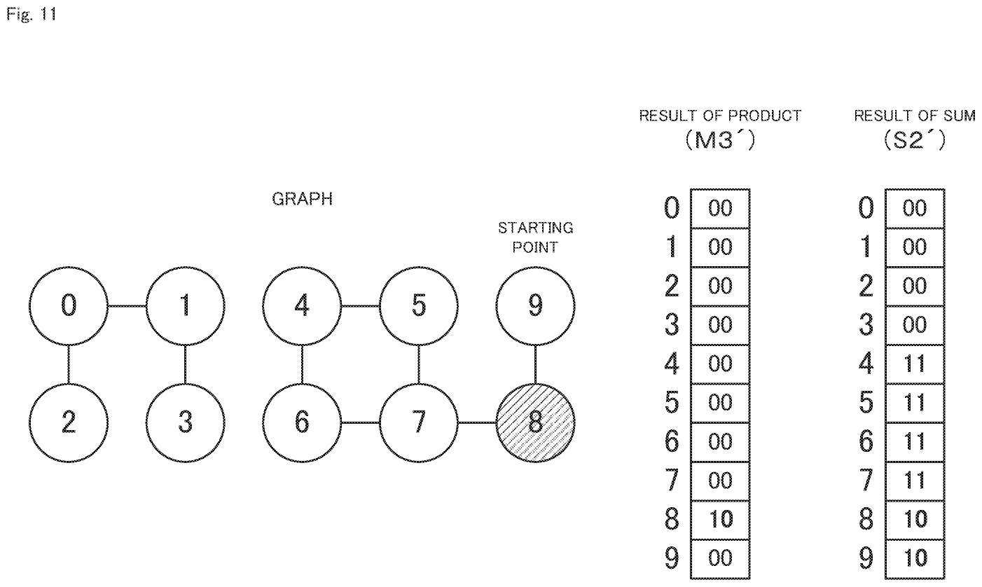

Subsequently, the classification unit 12 calculates a result (S2′: second matrix) of the sum of the result (M2′) of the product of FIG. 10 and the frontier matrix (F3′) of FIG. 2. In the result (S2′) of the sum of FIG. 11, the elements corresponding to the vertices 4 to 9 that have already been searched are labeled. In this way, it continues until all of the elements corresponding to the vertices 4 to 9 are labeled with the label “11”.

According to Modification 1, even if the vertices are selected in the same connected set, since the labels in the same connected set can be set to the same label, the vertices can be classified.

[Modification 2]

If the vertices selected by the generation unit 11 are in the same connected set, since different labels are respectively set for the selected vertices, the classification unit 12 will attach different labels respectively to the vertices in the same connected set. In this case, the classification will be different from the actual graph.

In Modification 2, even if different labels are respectively set for the vertices in the same connected set, the labels of the vertices in the same connected set are unified to the same label, and thus they can be classified in the same way as the actual graph.

In Modification 2, if the classification unit 12 detects duplicate vertices, the classification unit 12 generates connection information indicating that the vertices that are the starting points of the duplicate vertices are in the same connected set and stores the connection information in a storage unit. Further, the classification unit 12 selects a label corresponding to any of the starting points of the duplicate vertices and sets it for the corresponding element of the second matrix. Thereafter, the classification unit 12 unifies the labels of the elements corresponding to the vertices in the same connected set based on the connection information after the labels are set for all of the elements of the second matrix.

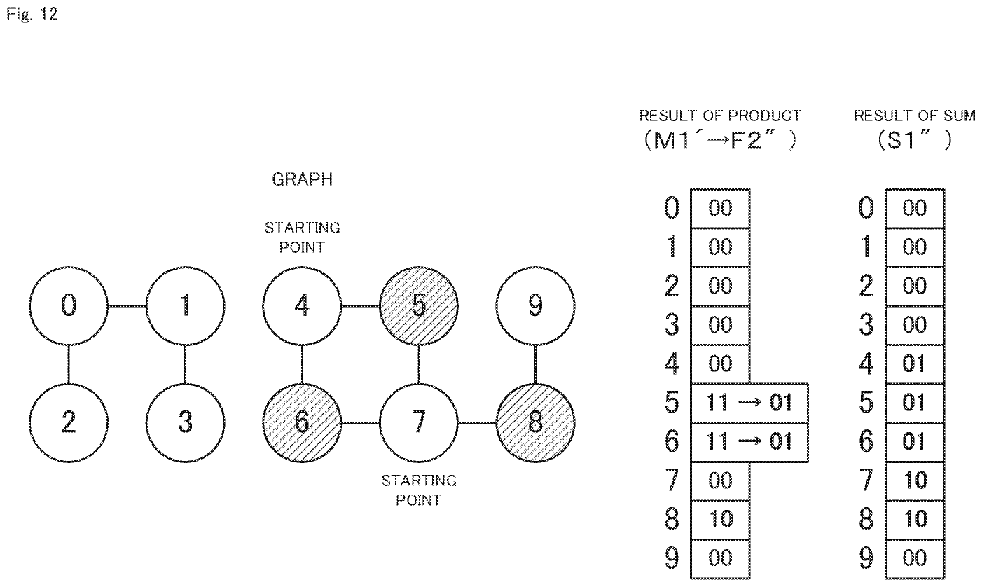

Modification 2 will be described with reference to FIGS. 8 and 12 to 14. FIGS. 12, 13, and 14 are diagrams for describing an example of an operation of Modification 2.

In the example of FIG. 8, since the vertices 4 and 7 are selected as the starting points, the generation unit 11 generates the frontier matrix (F1′).

The example of FIG. 12 is an example in which the classification unit 12 generates the result (M1′) of the product of the adjacency matrix (R) of FIG. 2 and the frontier matrix (F1′) of FIG. 8. In the example of FIG. 12, since the vertices adjacent to the vertex 4 are the vertices 5 and 6, and the vertices adjacent to the vertex 7 are the vertices 5, 6, and 8, the vertices 5 and 6 are duplicated. That is, the vertices 4 to 7 are in the same connected set.

In such a case, since “11” is attached to the elements corresponding to the vertices 5 and 6 of the result (M1′) of the product, the classification unit 12 stores in the storage unit the connection information indicating that the vertices 4, 5, 6, and 7 are in the same connected set. Alternatively, the classification unit 12 may store in the storage unit the connection information indicating that the vertices labeled with the label “01” or the label “10” are in the same connected set.

Note that the classification unit 12 sets the label “01” set for the vertex 4 or the label “10” set for the vertex 7 for the elements corresponding to the duplicate vertices 5 and 6 of the result (M1′) of the product.

Subsequently, the result (M1′) of the product of FIG. 12 is used as a frontier matrix (F2″). In the example of FIG. 12, since the result (M1′) of the product does not have an element corresponding to the searched vertices, the result (M1′) of the product is used as a new frontier matrix (F2″).

Subsequently, the classification unit 12 calculates the result (S1″: second matrix) of the sum of the result (M1′) of the product of FIG. 12 and the frontier matrix (F1′) of FIG. 8. In the result (S1″) of the sum of FIG. 12, the elements corresponding to the vertices 4, 5, 6, 7, and 8 that have already been searched are labeled.

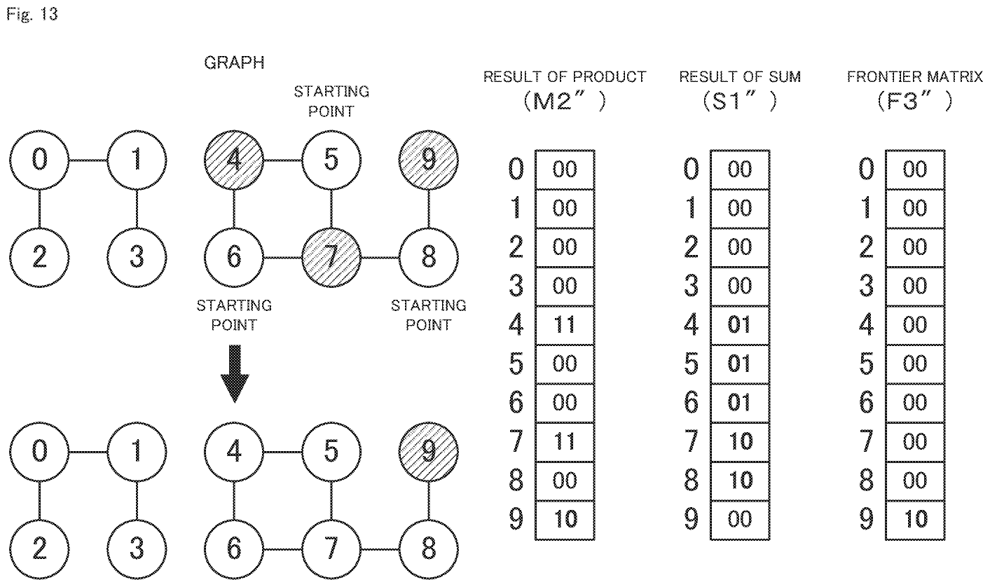

The example of FIG. 13 is an example in which the classification unit 12 generates the result (M2″) of the product of the adjacency matrix (R) of FIG. 2 and the frontier matrix (F2″) of FIG. 12. In the example of FIG. 13, since the result (M2″) of the product has labels for the elements corresponding to the searched vertices 4, 7, and 9, the elements corresponding to the searched vertices are excluded from the result (M2″) of the product. Then, as illustrated in FIG. 13, a new frontier matrix (F3″) is generated in which the labeled element corresponding to the vertex 9 remains and “00” is assigned to the other vertices.

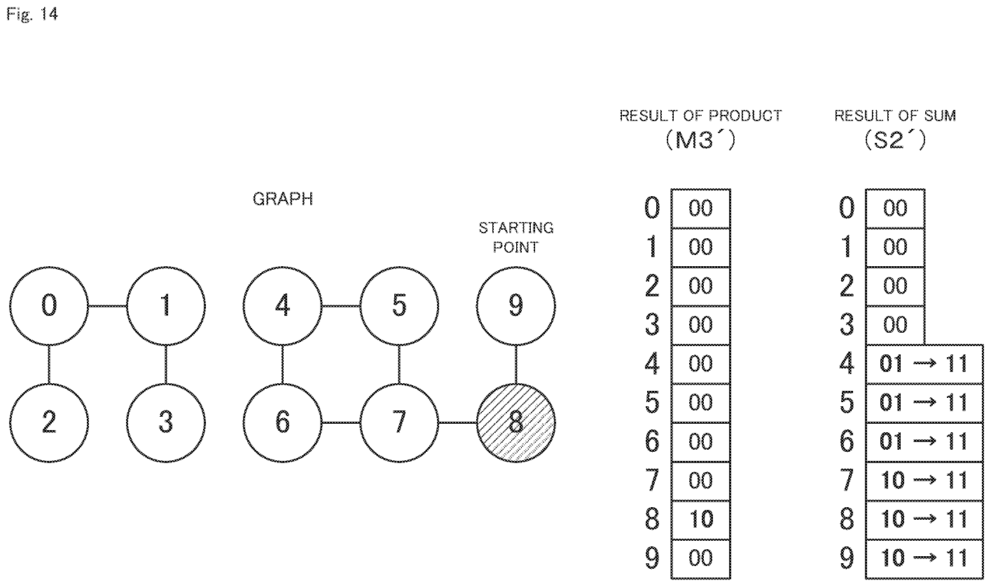

Subsequently, the classification unit 12 calculates the result (S2″: second matrix) of the sum of the result (M2″) of the product of FIG. 13 and the frontier matrix (F3″) of FIG. 2. In the result (S2″) of the sum of FIG. 14, the elements corresponding to the vertices 4 to 9 that have already been searched are labeled.

Subsequently, when the vertices 4 to 9 of the result (S2″) of the sum are labeled, the classification unit 12 unifies the labels corresponding to the vertices in the same connected set to the same label based on the connection information. For example, as illustrated in FIG. 13, the labels are set to “11”, which is the logical sum of the label “01” corresponding to the vertex 4 and the label “10” corresponding to the vertex 7.

According to Modification 2, even if vertices are selected in the same connected set, since the labels in the same connected set can be set to the same label, the vertices can be classified.

[Device Operation]

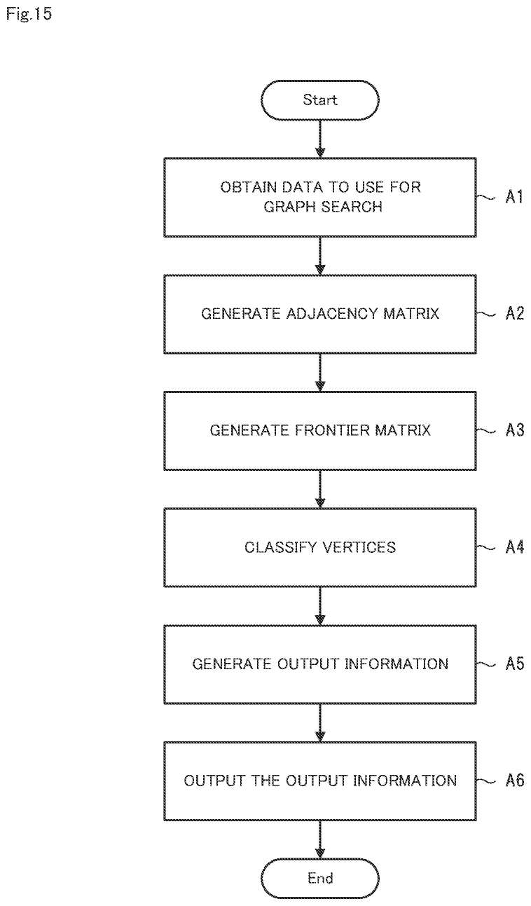

Subsequently, the operation of the graph searching apparatus in the embodiment, and Modifications 1 and 2 of the present invention will be described with reference to FIG. 15.

FIG. 15 is a diagram for describing an example of the operation of the graph searching apparatus. In the following description, FIG. 1 will be referred to as appropriate. Further, in the present example embodiment, and Modifications 1 and 2, a graph searching method is performed by operating the graph searching apparatus. Therefore, description of the graph searching method in the present example embodiment and Modifications 1 and 2 will be replaced with the following description of the operation of the graph searching apparatus.

As illustrated in FIG. 15, first, the obtaining unit 13 obtains data required for performing a graph search on a target graph (step A1). Specifically, in step A1, the obtaining unit 13 receives the data transmitted from the external device 20 and outputs the data to the adjacency matrix generation unit 14.

Subsequently, the adjacency matrix generation unit 14 generates the adjacency matrix representing the adjacency relationship of vertices for the target graph by using the data required for the graph search (step A2). Specifically, in step A2, the adjacency matrix generation unit 14 first obtains the data required for the graph search. Subsequently, in step A2, the adjacency matrix generation unit 14 generates the adjacency matrix corresponding to the target graph by using the vertices included in the target graph and the adjacency relationship of each vertex. The adjacency matrix generation unit 14 generates, for example, the adjacency matrix (R) as illustrated in FIG. 2 described above.

Subsequently, the generation unit 11 selects vertices based on the adjacency relationship of the vertices included in the graph, and generates a frontier matrix in which different labels are respectively set for the elements corresponding to the selected vertices (step A3). Specifically, in step A3, the generation unit 11 first selects vertices from the vertices included in the graph.

For the selection of vertices, for example, the user may select the vertices as appropriate, or the generation unit 11 may select the vertices. Note that when the generation unit 11 selects the vertices, the generation unit 11 may select preset vertices or may select the vertices based on the number of vertices.

Subsequently, in step A3, the generation unit 11 sets different labels for elements corresponding to the selected vertices of a frontier matrix having the same number of rows as the number of vertices. The generation unit 11 generates, for example, the frontier matrix (F1) as illustrated in FIG. 2 described above. Further, the generation unit 11 determines the bit width of the label based on the number of selected vertices.

Subsequently, the classification unit 12 generates a new frontier matrix by referring to the result (second matrix) of the sum representing the vertices for which the graph search has been completed, and excluding the elements corresponding to the searched vertices from the result (first matrix) of the product of the adjacency matrix and the frontier matrix (step A4). Thereafter, the classification unit 12 classifies the vertices by calculating the sum of the result of the product and the result of the sum and generating a new result (second matrix) of the sum.

Specifically, the classification unit 12 first obtains the adjacency matrix and the frontier matrix in step A4. Subsequently, the classification unit 12 calculates the result of the product of the adjacency matrix and the frontier matrix in step A4.

Subsequently, in step A4, the classification unit 12 generates the new frontier matrix by referring to the result of the sum and excluding the elements corresponding to the searched vertices from the result of the product if the result of the product has searched vertices. The generation unit 11 generates the new frontier matrices (F3) (F4), for example, as described above with reference to FIGS. 4 and 5.

Subsequently, in step A4, the classification unit 12 classifies the vertices by calculating the sum of the result of the product and the result of the sum and generating a new result of the sum. The generation unit 11 generates the new results (S1), (S2), and (S3) of the sum, for example, as described above with reference to FIGS. 3 to 6.

Subsequently, the output information generation unit 15 generates the output information to be used to output one or more of the graph, the adjacency matrix, the frontier matrix, the result of the product, the result of the sum, and the like to the output device (step A5). Thereafter, the output information generation unit 15 transmits the generated output information to the output device (step A6).

[Modification 1]

The operation of Modification 1 will be described with reference to FIGS. 8 to 11. In step A3, when the vertices 4 and 7 illustrated in FIG. 8 are selected as the starting points, the generation unit 11 generates the frontier matrix (F1′).

Subsequently, in step A4, the classification unit 12 generates the result (M1′) of the product of the adjacency matrix (R) of FIG. 2 and the frontier matrix (F1′) of FIG. 8. At this time, since the vertices adjacent to the vertex 4 are the vertices 5 and 6, and the vertices adjacent to the vertex 7 are the vertices 5, 6, and 8, the vertices 5 and 6 are duplicated. In such a case, the classification unit 12 attaches the label “11” representing the logical sum of the label “01” set for the vertex 4 and the label “10” set for the vertex 7 to the elements corresponding to the duplicate vertices 5 and 6.

Subsequently, in step A4, the classification unit 12 uses the result (M1′) of the product of FIG. 9 as the frontier matrix (F2′). In the example of FIG. 9, since the result (M1′) of the product does not have the element corresponding to the searched vertices, the result (M1′) of the product is used as the new frontier matrix (F2′).

Subsequently, in step A4, the classification unit 12 calculates the result (S1′: second matrix) of the sum of the result (M1′) of the product of FIG. 9 and the frontier matrix (F1′) of FIG. 8. The sum result (S1′) is the matrix for representing the searched vertices. Therefore, in the result (S1′) of the sum of FIG. 9, the elements corresponding to the vertices 4, 5, 6, 7, and 8 that have already been searched are labeled.

Subsequently, in step A4, the classification unit 12 generates the result (M2′) of the product of the adjacency matrix (R) of FIG. 2 and the frontier matrix (F2′) of FIG. 9. At this time, since the vertices adjacent to the vertex 5 are the vertices 4 and 7, and the vertices adjacent to the vertex 6 are the vertices 4 and 7, the adjacent vertices are duplicated for the vertices 4 and 7. In such a case, the classification unit 12 attaches the label “11” to the elements corresponding to the duplicate vertices 4 and 7.

Subsequently, in step A4, the classification unit 12 generates a frontier matrix (F3′) using the result (M2′) of the product and the result (S1′) of the sum of FIG. 10. In the example of FIG. 10, since the result (M2′) of the product has labels for the elements corresponding to the searched vertices 4, 7, and 9, the elements corresponding to the searched vertices are excluded from the result (M2′) of the product. Then, as illustrated in FIG. 10, the new frontier matrix (F3′) is generated in which the labeled element corresponding to the vertex 9 remains and “00” is assigned to the other vertices.

Subsequently, in step A4, the classification unit 12 calculates a result (S2′: second matrix) of the sum of the result (M2′) of the product of FIG. 10 and the frontier matrix (F3′) of FIG. 2. In the result (S2′) of the sum of FIG. 11, the elements corresponding to the vertices 4 to 9 that have already been searched are labeled.

[Modification 2]

The operation of Modification 2 will be described with reference to FIGS. 8 and 12 to 14.

In step A3, when the vertices 4 and 7 illustrated in FIG. 8 are selected as the starting points, the generation unit 11 generates the frontier matrix (F1′).

In step 4, if the classification unit 12 detects duplicate vertices, the classification unit 12 generates connection information indicating that the vertices that are the starting points of the duplicate vertices are in the same connected set and stores the connection information in a storage unit. Further, the classification unit 12 selects the label corresponding to any of the starting points of the duplicate vertices and sets it for the corresponding element of the second matrix. Thereafter, the classification unit 12 unifies the labels of the elements corresponding to the vertices in the same connected set based on the connection information after the labels are set for all the elements of the second matrix.

Specifically, in step A4, the classification unit 12 first generates the result (M1′) of the product of the adjacency matrix (R) of FIG. 2 and the frontier matrix (F1′) of FIG. 8. In the example of FIG. 12, since the vertices adjacent to the vertex 4 are the vertices 5 and 6, and the vertices adjacent to the vertex 7 are the vertices 5, 6, and 8, the vertices 5 and 6 are duplicated. That is, the vertices 4 to 7 are in the same connected set.

In such a case, since “11” is attached to the elements corresponding to the vertices 5 and 6 of the result (M1′) of the product, in step A4, the classification unit 12 stores in the storage unit the connection information indicating that the vertices 4, 5, 6, and 7 are in the same connected set. Alternatively, in step A4, the classification unit 12 may store in the storage unit the connection information indicating that the vertices labeled with the label “01” or the label “10” are in the same connected set.

Note that, in step A4, the classification unit 12 sets the label “01” set for the vertex 4 or the label “10” set for the vertex 7 for the elements corresponding to the duplicate vertices 5 and 6 of the result (M1′) of the product.

Subsequently, in step A4, the classification unit 12 uses the result (M1′) of the product of FIG. 12 as the frontier matrix (F2″). In the example of FIG. 12, since the result (M1′) of the product does not include an element corresponding to a searched vertex, the result (M1′) of the product is used as the new frontier matrix (F2″).

Subsequently, in step A4, the classification unit 12 calculates the result (S1“: second matrix) of the sum of the result (M1′) of the product of FIG. 12 and the frontier matrix (F1′) of FIG. 8. In the result (S1”) of the sum of FIG. 12, the elements corresponding to the vertices 4, 5, 6, 7, and 8 that have already been searched are labeled.

Subsequently, in step A4, the classification unit 12 generates the result (M2″) of the product of the adjacency matrix (R) of FIG. 2 and the frontier matrix (F2″) of FIG. 12. In the example of FIG. 13, since the result (M2″) of the product includes the labels for the elements corresponding to the searched vertices 4, 7, and 9, the elements corresponding to the searched vertices are excluded from the result (M2″) of the product. Then, as illustrated in FIG. 13, the new frontier matrix (F3″) is generated in which the labeled element corresponding to the vertex 9 remains and “00” is assigned to the other vertices.

Subsequently, in step A4, the classification unit 12 calculates the result (S2″: second matrix) of the sum of the result (M2″) of the product of FIG. 13 and the frontier matrix (F3″) of FIG. 2. In the result (S2″) of the sum of FIG. 14, the elements corresponding to the vertices 4 to 9 that have already been searched are labeled.

Subsequently, in step A4, when the vertices 4 to 9 of the result (S2″) of the sum are labeled, the classification unit 12 unifies the labels corresponding to the vertices in the same connected set to the same label based on the connection information. For example, as illustrated in FIG. 13, the labels are set to “11”, which is the logical sum of the label “01” corresponding to the vertex 4 and the label “10” corresponding to the vertex 7.

[Effect of the Present Example Embodiment]

As described above, according to the present example embodiment, since the adjacency matrix and the frontier matrix are used to classify the vertices, the time required for the graph search can be reduced.

In addition, conventionally, when performing a graph search using a processor or the like, one vertex is selected, the graph search is completed for the selected vertex, then one next vertex is selected, and the graph search is sequentially performed. However, in the present example embodiment, since the vertices are selected and the graph search is performed in parallel, the number of steps required for the graph search can be reduced as compared with the conventional case.

According to Modifications 1 and 2, even when the vertices are selected in the same connected set, since the labels in the same connected set can be set to the same label, the vertices can be classified.

[Program]

The program according to the embodiment of the present invention may be any program that causes the computer to execute steps A1 to A6 illustrated in FIG. 15. By installing and executing this program on the computer, it is possible to realize the graph searching apparatus and the graph searching method in the present example embodiment. In this case, the computer processor functions as the obtaining unit 13, the adjacency matrix generation unit 14, the generation unit 11, the classification unit 12, and the output information generation unit 15, to perform processing.

Further, the program in the present example embodiment may be executed by a computer system constructed by a plurality of computers. In this case, for example, each computer may function as any of the obtaining unit 13, the adjacency matrix generation unit 14, the generation unit 11, the classification unit 12, and the output information generation unit 15.

[Physical Configuration]

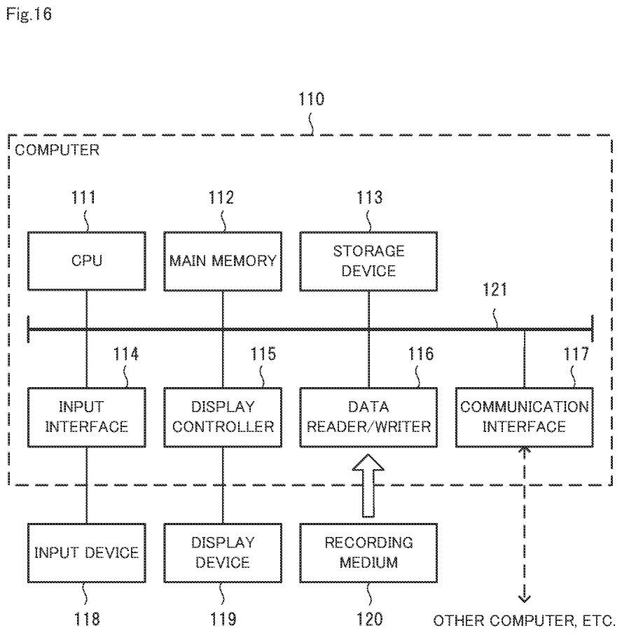

Here, the computer for realizing the graph searching apparatus by executing the programs in the embodiment, and Modifications 1 and 2 will be described with reference to FIG. 16. FIG. 16 is a block diagram illustrating an example of the computer for realizing the graph searching apparatus according to the embodiment, and Modifications 1 and 2 of the present invention.

As illustrated in FIG. 16, a computer 110 includes a CPU 111, a main memory 112, a storage device 113, an input interface 114, a display controller 115, a data reader/writer 116, and a communication interface 117. These parts are connected to each other via a bus 121 so as to be capable of data communication. Note that the computer 110 may include a graphics processing unit (GPU) or a field-programmable gate array (an FPGA) in addition to the CPU 111 or in place of the CPU 111.

The CPU 111 expands the program (code) in the present example embodiment stored in the storage device 113 into the main memory 112 and executes the program in a predetermined order to perform various operations. The main memory 112 is typically a volatile storage device such as a dynamic random access memory (DRAM). Further, the program in the present example embodiment is provided in a state of being stored in a computer-readable recording medium 120. The program in the present example embodiment may be distributed on the Internet connected via the communication interface 117. Note that the recording medium 120 is a non-volatile recording medium.

Further, examples of the storage device 113 include a semiconductor storage device such as a flash memory in addition to a hard disk drive. The input interface 114 mediates data transmission between the CPU 111 and an input device 118 such as a keyboard and a mouse. The display controller 115 is connected to a display device 119 and controls display on the display device 119.

The data reader/writer 116 mediates the data transmission between the CPU 111 and the recording medium 120, reads the program from the recording medium 120, and writes a processing result in the computer 110 to the recording medium 120. The communication interface 117 mediates the data transmission between the CPU 111 and another computer.

Further, examples of the recording medium 120 include a general-purpose semiconductor storage device such as a compact flash (CF) (registered trademark) and a secure digital (SD), a magnetic recording medium such as a flexible disk, or an optical recording medium such as a compact disk read only memory (CD-ROM).

Note that the graph searching apparatus 10 in the present example embodiment can also be implemented using hardware corresponding to each part instead of the computer in which the program is installed. Further, the graph searching apparatus 10 may be partially implemented by a program and the rest may be implemented by hardware.

[Supplementary Notes]

Regarding the above-described example embodiment, the following supplementary notes are further disclosed. A part or all of the above-described example embodiment can be described by (Supplementary note 1) to (Supplementary note 10) described below, but is not limited to the following description.

(Supplementary Note 1)

A graph searching apparatus including:

a generation unit configured to select a plurality of vertices based on an adjacency relationship of vertices included in a graph and generate a frontier matrix in which different labels are respectively set for elements corresponding to the selected vertices; and

a classification unit configured to classify the vertices using the frontier matrix and an adjacency matrix representing the adjacency relationship of the vertices included in the graph.

(Supplementary Note 2)

The graph searching apparatus described in supplementary note 1, in which

the classification unit

generates a new frontier matrix by referring to a second matrix representing vertices for which a graph search has been completed and excluding elements corresponding to the searched vertices from a first matrix that is the product of the adjacency matrix and the frontier matrix, and classifies the vertices by calculating the sum of the first matrix and the second matrix and generating a new second matrix.

(Supplementary Note 3)

The graph searching apparatus described in supplementary note 1 or 2, in which the label determines a bit width based on the number of vertices that are starting points.

(Supplementary Note 4)

The graph searching apparatus described in any one of supplementary notes 1 to 3, in which the generation unit and the classification unit are operated using a vector processor.

(Supplementary Note 5)

A graph searching method including:

(a) a step of selecting a plurality of vertices based on an adjacency relationship of vertices included in a graph and generating a frontier matrix in which different labels are respectively set for elements corresponding to the selected vertices; and
(b) a step of classifying the vertices using the frontier matrix and an adjacency matrix representing the adjacency relationship of the vertices included in the graph.

(Supplementary Note 6)

The graph searching method described in supplementary note 5, in which

in the (b) step,

a new frontier matrix is generated by referring to a second matrix representing vertices for which a graph search has been completed and excluding elements corresponding to the searched vertices from a first matrix that is the product of the adjacency matrix and the frontier matrix; and

the vertices are classified by calculating the sum of the first matrix and the second matrix and generating a new second matrix.

(Supplementary Note 7)

The graph searching method described in supplementary note 5 or 6, in which the label determines a bit width based on the number of vertices that are starting points.

(Supplementary Note 8)

A computer readable recording medium including a program recorded thereon, the program including instructions for causing a computer to carry out:

(a) a step of selecting a plurality of vertices based on an adjacency relationship of vertices included in a graph and generating a frontier matrix in which different labels are respectively set for elements corresponding to the selected vertices; and
(b) a step of classifying the vertices using the frontier matrix and an adjacency matrix representing the adjacency relationship of the vertices included in the graph.

(Supplementary Note 9)

The computer readable recording medium described in supplementary note 8, in which

in the (b) step,

a new frontier matrix is generated by referring to a second matrix representing vertices for which a graph search has been completed and excluding elements corresponding to the searched vertices from a first matrix that is the product of the adjacency matrix and the frontier matrix, and

the vertices are classified by calculating the sum of the first matrix and the second matrix and generating a new second matrix.

(Supplementary Note 10)

The computer readable recording medium described in supplementary note 8 or 9, in which

the label determines a bit width based on the number of vertices that are starting points.

Although the present invention has been described above with reference to the example embodiment, the present invention is not limited to the above example embodiment. Various changes that can be understood by those skilled in the art can be made within the scope of the present invention in terms of the structure and details of the present invention.

### INDUSTRIAL APPLICABILITY

As described above, according to the present invention, the time required for graph search can be reduced. The present invention is useful in fields where graph search is required. For example, it can be used for analysis of SNS, analysis of a road connecting points on an electronic map, and the like.

### REFERENCE SIGNS LIST

10 Graph searching apparatus
10 Generation unit
12 Classification unit
13 Obtaining unit
14 Adjacency matrix generation unit
15 Output information generation unit
20 External device
30 Output device
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. A graph searching apparatus comprising:
a processor; and
a memory storing program code executable by the processor to:
select a plurality of vertices based on an adjacency relationship of vertices included in a graph and generate a frontier matrix in which different labels are respectively set for elements corresponding to the selected vertices; and
classify the vertices using the frontier matrix and an adjacency matrix representing the adjacency relationship of the vertices included in the graph.

2. The graph searching apparatus according to claim 1, wherein
the processor
generates a new frontier matrix by referring to a second matrix representing vertices for which a graph search has been completed and excluding elements corresponding to the searched vertices from a first matrix that is the product of the adjacency matrix and the frontier matrix, and
classifies the vertices by calculating the sum of the first matrix and the second matrix and generating a new second matrix.

3. The graph searching apparatus according to claim 1, wherein
the label determines a bit width based on the number of vertices that are starting points.

4. The graph searching apparatus according to claim 1, wherein
the generation and the classification are operated using a vector processor as the processor.

5. A graph searching method comprising:
selecting a plurality of vertices based on an adjacency relationship of vertices included in a graph and generating a frontier matrix in which different labels are respectively set for elements corresponding to the selected vertices; and
classifying the vertices using the frontier matrix and an adjacency matrix representing the adjacency relationship of the vertices included in the graph.

6. The graph searching method according to claim 5, wherein
in the classifying,
a new frontier matrix is generated by referring to a second matrix representing vertices for which a graph search has been completed and excluding elements corresponding to the searched vertices from a first matrix that is the product of the adjacency matrix and the frontier matrix; and
the vertices are classified by calculating the sum of the first matrix and the second matrix and generating a new second matrix.

7. The graph searching method according to claim 5, wherein
the label determines a bit width based on the number of vertices that are starting points.

8. A non-transitory computer readable recording medium including a program recorded thereon, the program including instructions for causing a computer to carry out:
selecting a plurality of vertices based on an adjacency relationship of vertices included in a graph and generating a frontier matrix in which different labels are respectively set for elements corresponding to the selected vertices; and
classifying the vertices using the frontier matrix and an adjacency matrix representing the adjacency relationship of the vertices included in the graph.

9. The non-transitory computer readable recording medium according to claim 8, wherein
in the classifying,
a new frontier matrix is generated by referring to a second matrix representing vertices for which a graph search has been completed and excluding elements corresponding to the searched vertices from a first matrix that is the product of the adjacency matrix and the frontier matrix, and
the vertices are classified by calculating the sum of the first matrix and the second matrix and generating a new second matrix.

10. The non-transitory computer readable recording medium according to claim 8, wherein
the label determines a bit width based on the number of vertices that are starting points.
